(19) United States
(12) Patent Application Publication
(10) Pub. No.: US 2012/0070256 A1
(43) Pub. Date: Mar. 22, 2012

(54) Devices for Transporting Reels of Material

(76) Inventors: Erwin Paul Josef LEHRIEDER, Gaukonigshofen (DE); Josef Herbert Olbort, Mainbernheim (DE)

(21) Appl. No.: 13/052,479

(22) Filed: Mar. 21, 2011

Related U.S. Application Data
(62) Division of application No. 10/590,390, filed on Aug. 23, 2006, now Pat. No. 8,011,871.

(30) Foreign Application Priority Data
Feb. 23, 2004 (DE) 102004008771.7
May 3, 2004 (DE) 102004021605.3

(51) Int. Cl. B65G 1/06

(52) U.S. Cl. 414/277

(57) ABSTRACT

Reels of material are transported by being disposed on a first transport carriage which is, in turn, disposed on a second transport carriage. The second transport carriage travels between a reel storage area, that has a plurality of storage spaces, and a reel changer of a web-processing machine. The second transport carriage, together with the first transport carriage and the reel of material that is deposited on the first transport carriage then travels to an offload or unload position of the reel changer.

### CROSS-REFERENCE TO RELATED APPLICATIONS

This patent application is a division of U.S. patent application Ser. No. 10/590,390, filed Aug. 23, 2006. That application is the U.S. National Phase, under 35 USC 371, of PCT/EP2005/050569, filed Feb. 9, 2005; published as WO 2005/080241 A2 and A3 on Sep. 1, 2005, and claiming priority to DE 10 2004 008 771.7, filed Feb. 23, 2004 and to DE 10 2004 021 605.3, filed May 3, 2004, the disclosures of which are expressly incorporated herein by reference.

### FIELD OF THE INVENTION

The present invention is directed to devices for transporting reels or rolls of material. The reels or rolls of material are stored in a storage area and are moved from the storage area to a web-processing machine on individual transport carriages.

### BACKGROUND OF THE INVENTION

In web-processing machines, such as in web-fed rotary printing presses, so-called reel changers are provided and serve to supply material, such as, for example, a web of printing material, to the web-processing machine. During a reel change, the wound off or exhausted reel of material is removed from the reel changer and is replaced by a new reel of material. Various transport systems for use in transporting the new reels of material to the reel changer or for transporting the wound off reels of material away from the reel changer are known from the prior art.

In EP 0 925 246 B1 and in EP 0 925 248A, there is described a complex system for use in transporting reels of material to and from the reel changer of a printing machine. In this prior device, the reels of material are stored, on their circumferential surfaces, on first transport carriages. The actual conveyance of the reels of material is then accomplished by loading the first transport carriages onto second transport carriages. This means, in other words, that the first transport carriages are loaded, piggyback, onto the second transport carriages. In the system described in EP 0 925 246 B1, a total of four different sections of rails or track for the second transport carriages are provided. None of the second transport carriages can move outside of the transport section to which they are assigned. Directly in front of the reel changer there is provided a section for a second transport carriage, which second transport carriage can be moved into an upload position and into an unload position for the reel changer. By loading a first transport carriage, on which a new reel of material is deposited, onto a second transport carriage in this section at the reel changer, the new reel of material can be brought into a position that is necessary for uploading. By loading a wound-off reel of material onto a first transport carriage that has been moved to the unload position, by the use of the second transport carriage, the wound-off reel of material can be transported away.

JP 63-074852 A shows a railless transport carriage with a device for lifting reels of material. This transport carriage removes the reels of material from intermediate storage stations and transports the reels of material to a reel changer.

US 2003/0071162 A1 DE 196 26 866 A1, DE 295 16 155 U1 and the article “Zaun erhöht Sicherheit im Maschinenumfeld”. Betriebstechnik Aktuell, Vogel Verlag GmbH, Würzburg, Vol. 39, No. 12, Dec. 1, 1998), p. 28. XP000792690, ISSN: 1434-8071” all describe security devices for transport and storage systems.

U.S. Pat. No. 5,076,751 A, DE 37 39 222 A1, U.S. Pat. No. 6,007,017 and DE 203 07 581 U1 disclose drives for transport systems for paper reels.

DE 41 35 001 A1 U.S. Pat. No. 4,537,368 A1 and JP62-157160 show devices for transporting reels of material from a storage area to a web-processing machine comprising multiple processing stations that are arranged one in front of another.

WO 03/080484 A1 describes a material transport system with a network of tracks and with transport carriages that can be moved on that network of tracks.

DE 39 10 444 A1 discloses a storage area for reels of paper. The paper reels are conveyed, via a reel carriage system, to a centrally arranged unpacking and splice-preparation station. After preparation, the reels of paper are reloaded onto the reel carriage system.

### SUMMARY OF THE INVENTION

The object of the present invention is to provide devices for transporting reels of material.

The object is attained according to the invention by transporting the reels of material from a storage area, that includes a plurality of storage spaces, to a web-processing machine that has multiple web processing stations and a reel changer. A transport route for a primary transport carriage, which carries a reel of material, is provided in front of the reel changer. Storage spaces for reels of material can be arranged on both sides of this transport route. Each of the primary transport carriages can be assigned to a specific one of the plurality of storage spaces. The primary transport carriage supporting a reel can, in turn, be supported on a secondary transport carriage which moves between the storage area and the reel changer.

One benefit of the device in accordance with the present invention consists particularly in that the second transport carriage can also be moved along at least one transport route into a storage area in which new and/or completely or partially wound-off material reels can be stored in a plurality of storage spaces. In this manner, the existing second transport carriage, which is used for uploading the reels of material into the reel changer, can also be used to transport the reels of material out of a storage area or into a storage area. Furthermore, it is within the scope of the present invention for the second transport carriage to either convey new reels of material directly to the reel changer, or for the new reels of material to be first placed in the storage area and stored there intermediately until retrieval for later use. Above all, with the device in accordance with the present invention, an awkward transfer among the individual sections for the different second transport carriages can be avoided.

In accordance with one preferred embodiment of the present invention, the storage area is configured as an intermediate storage area, and particularly in the manner of a daily storage area. In other words the storage area, which can be approached with the second transport carriage, serves not for storage of the entire inventory of reels of material. Rather, it is intended only for the intermediate storage of a specific, and preferably smaller, number of reels of material near the reel changer. In addition, the reels of material in the intermediate storage area are intended to have already been unpacked and to have been prepared for the reel change, with the appropriate splices. If the storage area is configured in the manner of a daily storage area, then roughly the number of reels of material that are required for daily use by the web-processing machine are placed in intermediate storage in this daily storage area.

In principle, it is possible for the reels of material to be unloaded from the first transport carriage in the storage spaces of the storage area. However, this can cause damage to the reels of material. The storage spaces in the storage area are therefore preferably configured such that at least one first transport carriage can be placed in each such storage space. Unloaded first transport carriages can also be placed in the different storage spaces in the storage area. This provides a storage space for the first transport carriages which is relatively close to the web-processing machine.

The arrangement of the transport carriages in the various storage spaces of the storage area should preferably be non-specific. As a result, ultimately any first transport carriage can be placed in any storage space in the storage area. In this manner, a very high degree of flexibility and variability in the use of the storage area is realized.

The functional scope for utilization of the second transport carriage can be substantially increased. The first transport carriage can also be moved along a transport route into an unpacking station for unpacking the reels of material. In this manner, once new reels of material have been unpacked in the unpacking station, they can be retrieved and can be transported to subsequent processing stations.

Further, it is especially advantageous, in accordance with the present invention, if the first transport carriage can also be moved along a transport route to a splice preparation station. In this manner, once the splices have been applied to the leading edge of the web, the unpacked reels of material can be retrieved from the splice preparation station and can then be transferred to subsequent processing stations. In addition, system configurations are also within the scope of the present invention in which particularly the splice preparation station also serves simultaneously as the unpacking station. The first transport carriage retrieves the reels of material from this combined station and transfers them to subsequent processing stations.

In the interest of the efficient transport of material, the unpacking station and/or the splice preparation station should be positioned in front of, or before the storage spaces in the storage area, relative to the direction of transport of the reels of material. In this manner, in the transport of unpacked reels of material, or of reels of material that have been prepared with splices, in the storage area, only very short transport routes are necessary. The unpacked or splice prepared reels of material can then be retrieved from the storage area at a later time via the second transport carriage, and can then be transferred to the reel changer.

In order to require the least possible amount of directional change, in the transport of the reels of material to the reel changer, it is particularly advantageous for the transport route in the storage area, on which the second transport carriage can be moved, to extend as a virtual extension of the direction of web travel in the web-processing machine.

As an alternative, or in addition to this, the transport route in the storage area can also extend parallel to the virtual extension of the direction of web travel in the web-processing machine. Very compact system configurations can be realized in this way.

The manner in which the storage spaces are configured in the storage area is essentially optional. According to one preferred embodiment of the present invention, branch lines, via which the storage spaces can be approached, extend off of the transport route in the storage area. In this manner, it is conceivable, for example, for the second transport carriage to transport the piggyback-loaded first transport carriages up to the branch line. The first transport carriage can then deposit the reel of material in the proper storage space by moving into the branch line. In this manner, the first transport carriage remains together with the corresponding reel of material in the storage space. The reel of material can be retrieved from the storage space and can be transported further by the first transport carriage being loaded onto the second transport carriage.

Depending on the configuration of the system of the present invention, storage spaces can be provided on both sides of the transport route. Alternatively, such storage spaces may be situated on only one side of the transport route.

For optimum functioning of the device of the present invention, the most precise possible positioning of the second transport carriage is of great importance. For example, if during unloading of a first transport carriage, the second transport carriage is positioned in front of a branch line, precise positioning of the second transport carriage is essential. Otherwise, the first transport carriage cannot be moved into the branch line. Therefore, a position-sensing system should be provided along at least certain sections of the transport route. The second transport carriage can be precisely positioned using this position-sensing system.

For reasons of occupational safety, an area security system should be provided. Such an area security system will secure the boundaries of the storage area against unauthorized entry

The area security system can be implemented by erecting a perimeter fence around the storage area. By using an existing area security system on the reel changer as a simultaneous area security system for the storage area, the expense required for implementing the area security system can be reduced.

To allow the transport of reels of material into or out of the storage area, a transfer channel can be provided in the area security system. In such a transfer channel area, the area security system should preferably operate without contact, such as, for example, by the use of photoelectric sensors or ultrasound sensors. By positioning such sensors at various levels, complex scanning patterns can be implemented. For example, reels of material can pass without difficulty into the transfer channel. However, an unauthorized exceeding of the sensor signals will trigger an alarm.

To prevent reels of material from being held too long in the storage area, the storage area should be operated according to the FIFO principle (first in, first out). This means that the reels of material, which are placed in the storage area first, are also transferred to the reel changer first.

### BRIEF DESCRIPTION OF THE DRAWINGS

Preferred embodiments of the present invention are illustrated in the set of drawings and wilt be described in greater detail in what follows.

The drawings show:

FIG. 1 a first preferred embodiment of a printing system with a device for transporting reels of material in accordance with the present invention; in

FIG. 2 a second preferred embodiment of a printing system with a device for transporting reels of material in accordance with the present invention; in

FIG. 3 a third preferred embodiment of a printing system with a device for transporting reels of material in accordance with the present invention; in

FIG. 4 a fourth preferred embodiment of a printing system with a device for transporting reels of material in accordance with the present invention; in

FIG. 5 side elevation view of a reel changer for use with the printing systems shown in FIG. 1 through FIG. 4; in

FIG. 6 a side elevation view, partly in cross-section of a device for transporting reels of material, with a transport carriage in various positions in accordance with the present invention; in

FIG. 7 a second preferred embodiment of the transport carriage, and configured to hold two reels of material; and in

FIG. 8 a further preferred embodiment of a printing system with two daily storage areas, in accordance with the present invention.

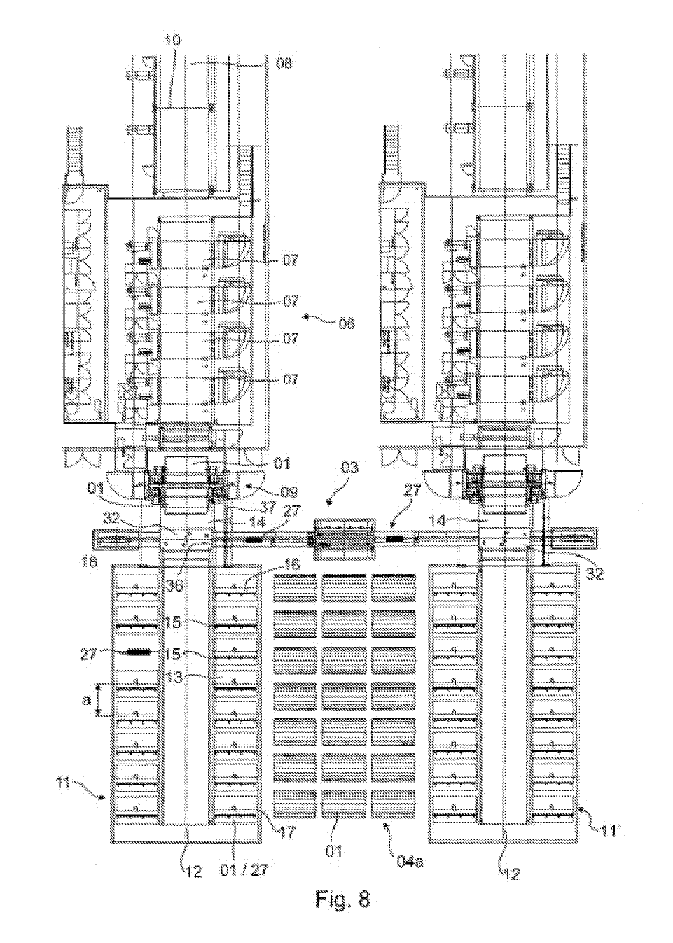

### DESCRIPTION OF THE PREFERRED EMBODIMENTS

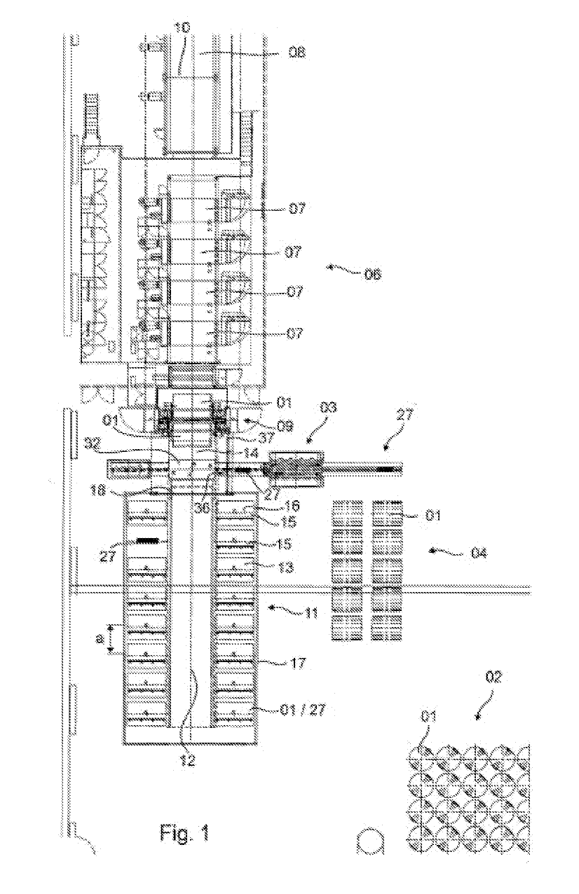

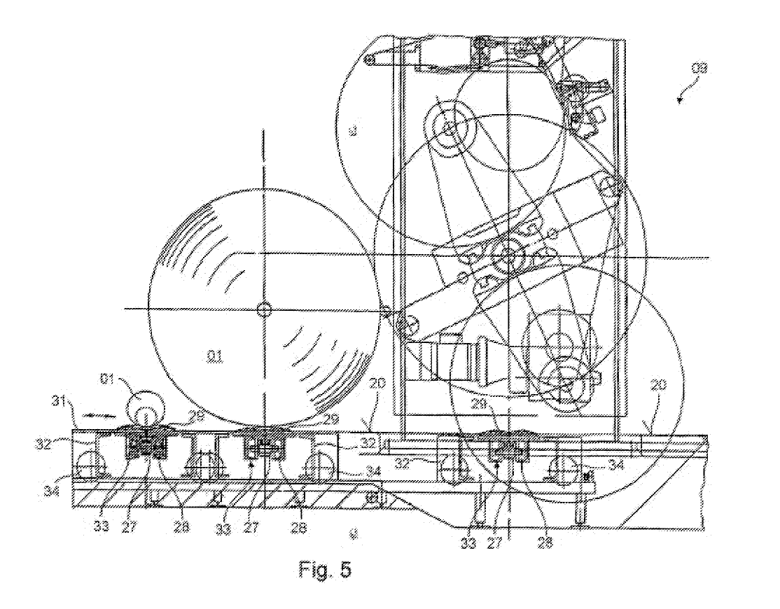

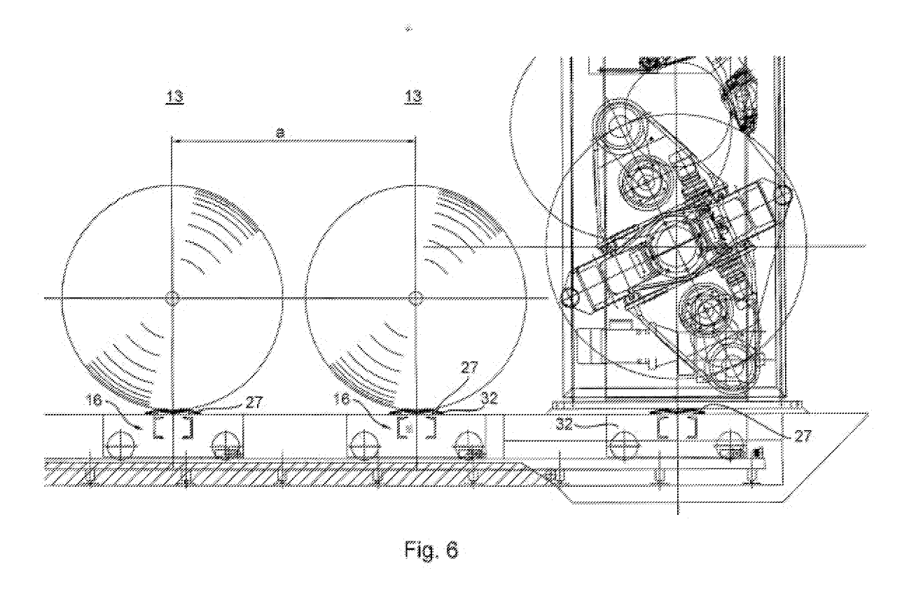

Referring initially to FIG. 1, there may be seen a schematic plan view of a printing system with a device for transporting reels of material 01 in accordance with the present invention. From a main storage area 02, packaged reels of material 01 are transported, via a suitable mode of transport, such as, for example, a clamping stacker truck, which is not specifically shown, to the area of a reel unpacking station 03, where they are deposited on a reel receiver 04. In the reel unpacking station 03, the reels of material 01 are manually rolled onto a first transport carriage 27. For this purpose, the first transport carriage 27 has a suitable trough on its upper surface as seen in FIGS. 5 and 6, which trough is configured to hold the reels of material 01 securely in place. By pressing a button, the reel of material 01 is transported to the center of the unpacking station 03, is centered, and then is manually unpacked. After the reel of material has been unpacked, the operators also apply the necessary splices 15 to the leading edge of the web of the reel of material 01. The unpacking station 03 thus serves, at the same time, as a splice preparation station 03.

As seen in FIGS. 1 to 4, there is provided a web-processing machine, generally at 06, which receives the web from the reel of material 01. The web-processing machine 06 is configured in the manner of a web-fed rotary printing press 06, in which a web of printing material passes through a plurality, and typically four printing couples 07 in sequence. In this web-processing machine or printing press 06, the web of printing material can, for example, be printed in four colors and on both sides, after which it is dried in a dryer 08. To supply the printing couples 07 with the web of printing material, a reel changer 09, in which two reels of material 01 can be mounted, is positioned in front of, or before, in a direction of web travel, the web-processing machine 06. With the reel changer 09, a flying reel change can be implemented without machine down time.

The web-fed rotary printing press is particularly configured as a gravure printing machine or as an offset printing machine, such as, for example, a commercial printing machine. Preferably, for example, the floor of the shop, the storage area and/or the reel changer and/or the printing couples are arranged, for example, one behind another in a single horizontal plane 20 or level, relative to the direction of web travel, as depicted in FIG. 5.

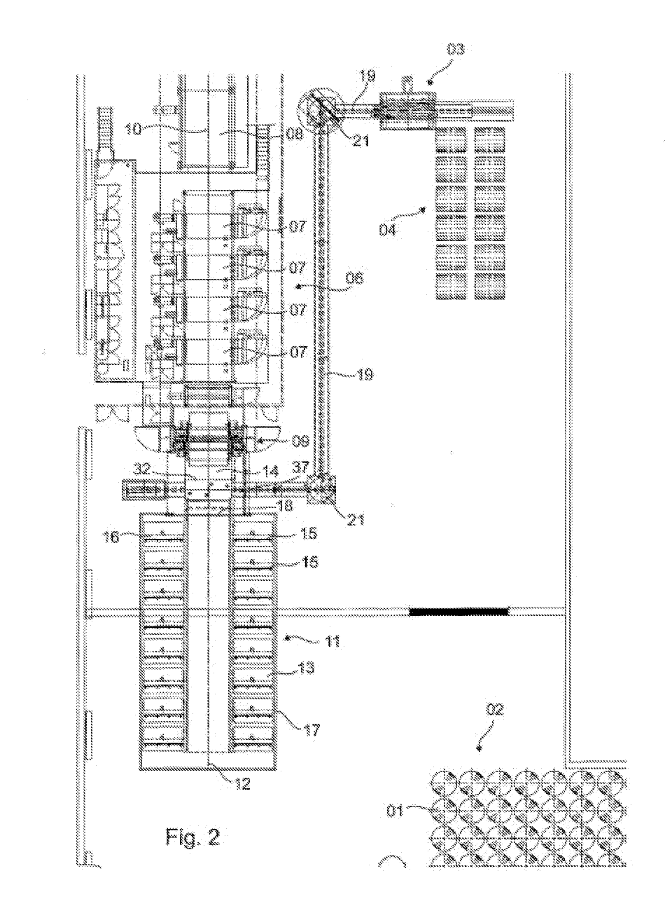

In the immediate vicinity of the reel changer 09, a storage area 11 is provided, as seen in FIGS. 1 and 2 which storage area 11 is configured as an intermediate storage area that is usable for storage of the reels of material 01 which are required for one day of operation of the web-processing machine 06. On each side of a transport route 12, which is also shown in FIGS. 1 and 2, eight storage spaces 13 are provided in the storage area 11. A first transport carriage 27, with a reel of material 01 deposited thereon, can be positioned in each such storage space 13.

Once the splices 15 have been prepared on the reel of material 01, another first transport carriage 27 takes over the reel of material 01 at the unpacking station, with the reel of material 01 in its raised position, and travels with it to the point of transfer onto a second transport carriage 32 which is depicted schematically in FIG. 1 and is shown more fully in FIGS. 5, 6 and 7. There, the first transport carriage 27 is loaded piggyback onto the second transport carriage 32. By moving the second transport carriage 32, the splice-prepared reel of material 01 can optionally be conveyed via a transport route 14 directly to the reel changer 09 or via the transport route 12 to the storage area 11. The decision as to whether the reel of material 01 will be transferred from the unpacking station 03 directly to the reel changer 09 or into the storage area 11 is made under the control of a material supply system which is not specifically shown.

If the splice-prepared reel of material 01 is to be conveyed to the storage area 11, the second or secondary transport carriage 32, with the first or primary transport carriage 27 loaded piggyback onto it, and with the reel of material 01 loaded onto the primary transport carriage 27, travels via the transport route 12 into the storage area 11 until it reaches an empty storage space 13. The second transport carriage 32 is then positioned in front of the empty storage space 13 such that the first or primary transport carriage 27 can be pushed into the branch line 16 of the specific empty storage space 13. The second or secondary transport carriage 32 then leaves the storage area 11, again via the transport route 12. The secondary transport carriage 32 can optionally also carry another first transport carriage 27 out of the storage area 11 as it departs. When a new reel of material 01 is requited on the reel changer 09, a reel of material 01 that has just been unpacked may be conveyed from the unpacking station 03, via the transport route 14, to the reel changer 09. Alternatively, a reel of material 01 that is already provided with splices 15 is conveyed from the storage area 11 to the reel changer 09.

The transport route 12 extends through the storage area 11 in a virtual extension of the direction of web travel through the web-processing machine 06. Accordingly, in the transport of a reel of material 01 out of the storage area 11 and to the reel changer 09, no change in direction of the second or secondary transport carriage 32 is necessary.

The storage area 11 is protected against unauthorized entry. On three sides of the storage area 11, unauthorized entry security is provided by a secured area, and especially by a perimeter fence. On a side of the storage area 11 that faces the reel changer 09, a transfer channel 18 is provided in the area security system 37 for the reel changer 09. In the area of the transfer channel 18, the area security system 37 is accomplished by the use of photoelectric beams or of sensors, such as, for example, laser sensors, which function without contact

The storage or the retrieval of the reels of material 01 in the storage area 11 is operated according to the FIFO principle, in order to prevent the reels of material 01 from being intermediately stored for too long a period in the storage area 11, which lengthy storage would cause the splices 15 to become unusable.

In FIG. 2, there is shown a schematic depiction of a second system in accordance with the present invention. This second embodiment differs from the first embodiment which is shown in FIG. 1 in that between the unpacking station 03 and the reel changer 09 or the storage area 11 there is provided an additional transport route 19. The second or secondary transport carriage 32 transports the piggyback-loaded first or primary transport carriage 27 and the reel of material 01 deposited thereon to the reel changer 09 or to the storage area 11 along this additional transport route 19. Two rotating platforms 21 are included in the transport route 19, to permit a change of direction of the first transport carriage 27 between the unpacking station 03 and the storage area 11 or the reel changer 09.

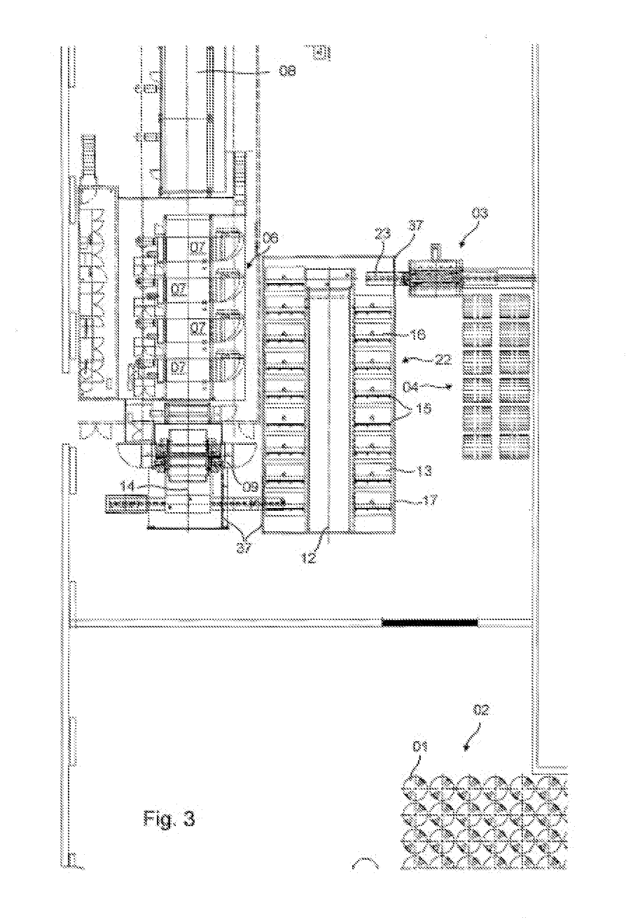

In the schematic depiction of a third preferred embodiment of a system in accordance with the present invention, as shown in FIG. 3, a storage area 22 that serves as an intermediate storage area is provided. A transport route 23 extends through the storage area 22, and runs perpendicular to the direction of web travel in the web-processing machine 06. During the transport of a reel of material 01 from the unpacking station 03 to the reel changer 09, the first transport carriage 27 passes through the entire storage area 22, along the transport route 23. Based upon requirements set forth by the control system of the material supply system, a splice-prepared reel of material 01 in the unpacking station 03 is either first placed in intermediate storage in the storage area 22 or is conveyed directly to the reel changer 09. Furthermore, a reel of material 01 that has already been prepared with splices 15 can be retrieved as needed from the storage area 22 and can be conveyed to the reel changer 09. In addition, the storage spaces 13 in the storage area 22 are located on both sides of the transport route 12, and thus are parallel to the web-processing machine 06, resulting in a highly compact system configuration.

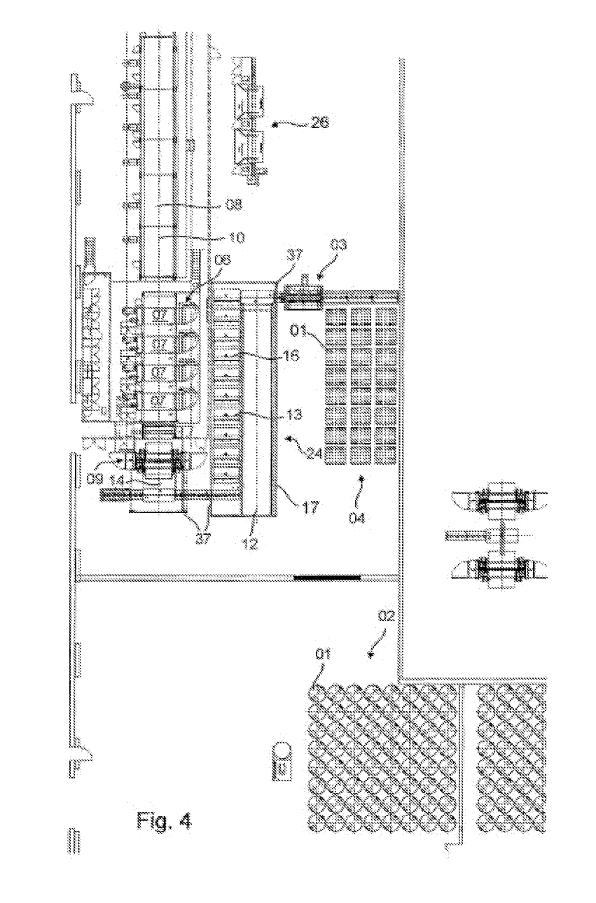

In FIG. 4, a fourth preferred embodiment of the present invention is illustrated, and which corresponds, to a large extent, to the system shown in FIG. 3. However, in contrast to the system shown in FIG. 3, in the storage area 24, storage spaces 13 are provided on only the left side of the transport route 12. Overall, an even more compact system configuration is enabled. The system is controlled via a control center 26.

In FIG. 5, a reel changer 09 is shown in side elevation view and partly in cross-section. First transport carriages 27 are used to transport new reels of material 01, and wound-off reels of material 01 to and from the reel changer 09. Primary transport carriages 27 of this system are, for example, rail-guided. The transport carriage 27 has four wheels or rollers 28 that travel on rails. To actuate the transport carriages 27, for example, a drag conveyor that extends underneath the floor can be provided, which drag conveyor is structured, for example, as a continuous chain. The transport carriage 27 is attached to this chain at least part of the time. A trough-shaped tray 29, which is configured to accommodate the reels of material 01, is attached to a support frame of the transport carriage 27. The trough-shaped tray 29, which serves as a receptacle for the reels of material 01, protrudes from the floor 31 of the storage room. The first transport carriage 27 itself proceeds recessed beneath the floor 31 of the storage room as may be seen most clearly in FIG. 5.

In each of the branch lines 16 of the storage spaces 13 of the intermediate storage areas 11, 22 or 24, segments of track are provided, in which track segments the wheels or rollers 28 of the first transport carriages 27 can run. In addition, in each storage space 13 a separate chain drive is provided. Preferably, at least the majority of the storage spaces 13 are each equipped with a separate chain drive.

The storage spaces 13 or branch lines 16 each hold a reel of material 01 or a transport carriage 27. However, they can also accommodate precisely 2, or more reels of material 01.

The second or secondary transport carriages 32 are used to convey the first or primary transport carriages 27 along the transport routes 12 and 14. A support frame of each second transport carriage 32 has a short segment of track 33, in which short track segment 33 the wheels or rollers 28 of a first transport carriage 27 can run. The second transport carriages 32 are also arranged underneath the floor and are each provided with four of their own wheels or rollers 34 that are guided on suitably configured rails. Chain drives can also be used to convey the second transport carriages 32.

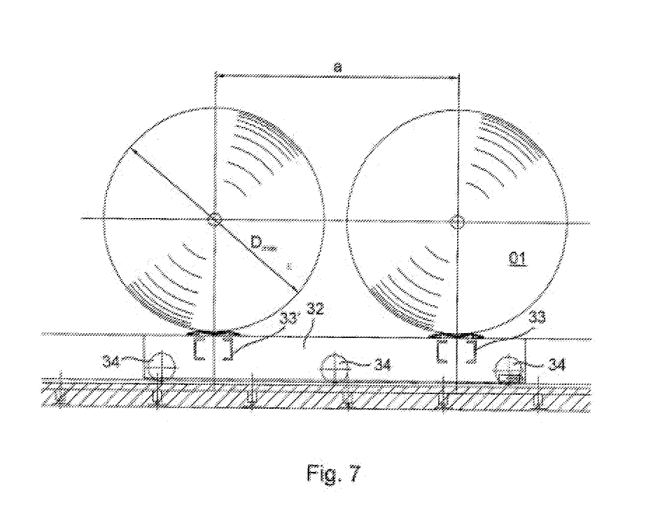

In an alternative embodiment, a single second transport carriage 32 can also have two segments of track 33; 33′, as depicted in FIG. 7. In this embodiment, a spacing distance “a” between the two segments of track 33; 33′ is greater than a maximum diameter Dₘₐₓ of any one of the reels of material 01 to be transported. Preferably, the distance “a” between the two segments of track 33; 33′ of the secondary transport carriage 32 is equal to a distance “a” between the segments of track 33; 33′ of the branch lines 16 of the storage spaces 13, as seen in FIG. 1.

At least one of the primary transport carriages 27 can carry an adapter, which is configured specifically to accommodate partially used reels, as seen in FIG. 5.

The longitudinal direction of the intermediate storage area, and the direction of web travel in the web-processing machine extend in essentially the same direction.

There are no rotating platforms for the transport carriages 27 arranged between the storage spaces 13 and the reel changer 09. Also, no rotating platforms are arranged between the storage spaces 13 and the splice preparation station 03 for the transport carriages 27.

At least one printing couple 07, the reel changer 09 and the storage spaces 13 are arranged nearly in a common plane 20, as depicted in FIG. 5. An arrangement of all of the printing couples 07 in a single common plane is advantageous. The web-processing machine further has a single reel changer. The transport route of the second or secondary transport carriage 32, and the longitudinal axis 10 of a dryer 08 of the web-processing machine are arranged such that they lie in alignment. Alternatively, they may be arranged in a parallel offset arrangement.

Lower edges of the relevant side frames of the printing couples 07 serve as the point of reference for the printing couples 07 and the reel changer 09. A mount of the transport carriages 27 serves as the point of reference for the storage spaces 13. The common plane 20 in this configuration is the floor of the building.

The device for transporting reels of material operates on the basis of the specific reel data recorded in the transport or preparation process. This specific reel data may be, for example, the bar code and/or the reel width and/or the reel status and/or the weights (gross weight, net weight 1, net weight 2) and/or the splice time and/or the no length, etc. This encompasses, for example, the data recording and/or data management and/or data allocation in the overall process, i.e. from the receipt of the unprepared reels up to disposal of the sheathing or reel core.

The data is maintained and managed in the relevant process steps. In connection with this, for example, the evaluation and the storage of this data, for the purpose of further utilization, can be implemented via a suitable management/support system. It is further possible to use the reel data, that are recorded via the reel changer/changers during and following the winding-off process, for entry into the specific record of information with respect to the reel and its allocation.

Furthermore, the device in accordance with the present invention is capable of handling partial reels or reels returned from the production process, and of managing them accordingly in the transport, preparation and data management processes. This includes all ancillary processes associated therewith. One component of this is the processes associated with the transport of partial reels, such as, for example, via adapters. The management of the adapters, with and without reels and of all processes necessary to accomplish this, can also be integrated, for example.

A further characterizing feature of a device in accordance with the present invention involves the use of multiple reel carriages for each storage area position. It also involves all the processes which are necessary to accomplish this.

One preferred embodiment, which is not specifically depicted also involves the use of a transfer table with multiple rail lines, which enables further optimizations of the device.

Another possible characterizing feature of a device in accordance with the present invention is the transport of the sleeve or core container, and its data content, to specific, such as, for example, freely selectable, positions in the storage area, or to other possible positions in the device. Further data transfers to the management system or to other evaluation units in the machine or to a production preparation system can also be included in this.

While preferred embodiments of devices for transporting reels of material, in accordance with the present invention, have been set forth fully and completely hereinabove, it will be apparent to one of skill in the art that various changes in, for example, the specific structure of the printing couples and of the reel changers, the specific splices placed on the web leading ends, and the like could be made without departing from the true spirit and scope of the present invention which is accordingly to be limited only by the appended claims.

What is claimed is:

1. Device for transporting reels of material (01) from a storage area (11; 22; 24) comprising a plurality of storage spaces (13) to a web-processing machine (06), wherein the web-processing machine (06) has multiple processing stations (07) arranged horizontally, one in front of another in a longitudinal direction, and a reel changer (09) is arranged horizontally in front of the processing stations (07, 08), wherein the storage spaces (13) are arranged parallel to the longitudinal direction and parallel to the processing stations (07), characterized in that the storage spaces (13) are arranged between the processing machine (06) and a transport route (12) for a transport carriage (32), which extends parallel to the longitudinal direction of the processing machine (06), for the purpose of removing the reels of material (01).

2. Device according to claim 1, characterized in that the reels of material (01) are removed from the storage spaces (13) from a side that faces away from the processing machine (06).

3. Device according to claim 1, characterized in that no transport route for a transport carriage (27; 32) is arranged between the processing station (07, 08) and the storage spaces (13).

4. Device according to claim 1, characterized in that the reels of material (01) are stored in the storage spaces (13) on first transport carriages (27).

5. Device according to claim 1, characterized in that based upon the direction of travel of the reels of material (01), the storage spaces (13) is arranged downstream from a preparation station (03) for the manual or automated application of splice elements.

6. Device according to claim 1, characterized in that a plurality of storage spaces (13) for reels of material (01) are arranged on both sides of the transport route (12).

7. Device according to claim 1, characterized in that the storage area (11; 22; 24) is designed in the manner of an intermediate storage area, especially in the manner of a daily storage area.

8. Device according to claim 1, characterized in that at least two reels of material (01) that have already been unpacked and prepared with splices (15) for the reel change are held in the storage spaces (13) of the storage area (11; 22; 24).

9. Device according to claim 8, characterized in that all new reels of material (01) are prepared with splices (15).

10. Device according to claim 1, characterized in that a first transport carriage (27) is arranged in each storage space (13) at least for a time.

11. Device according to claim 10, characterized in that the first transport carriages (27) can be placed in any of the storage spaces (13) of the storage area (11; 22; 24).

12. Device according to claim 1, characterized in that at least one first transport carriage (27) can also be moved along a transport route (19) into an unpacking station (03) for unpacking the reels of material (01).

13. Device according to claim 12, characterized in that at least one first transport carriage (27) can also be moved along a transport route (19) into a splice preparation station (03) for preparing the splices (15) on the reel of material (01).

14. Device according to claim 13, characterized in that the splice preparation station (03) can simultaneously be used as an unpacking station (03).

15. Device according to claim 1, characterized in that storage spaces (13) are provided on only one side of a transport route (12).

16. Device according to claim 1, characterized in that the storage area (11; 22; 24) is secured against unauthorized entry by means of a secured area (17; 37) installed along the perimeter of the store (11; 22; 24).

17. Device according to claim 16, characterized in that the secured area (17) of the storage area (11, 24) is formed in sections by a perimeter fence.

18. Device according to claim 16, characterized in that the secured area (17) of the storage area (11) is formed in sections by the area security system (37) of the reel changer (09).

19. Device according to one of claim 18, characterized in that at least one transfer channel (18) is provided in the area security system (37) to allow reels of material (01) to be transferred in and/or out.

20. Device according to claim 14, characterized in that the storage area (11) is secured against unauthorized entry in the area of the transfer channel (18) by photoelectric beams or ultrasound sensors.

21. Device according to claim 20, characterized in that multiple photoelectric beams of ultrasound sensors are provided, which are arranged at different levels.

22. Device according to claim 1, characterized in that multiple processing stations (07) are provided in the web-processing machine (06), one in front of another in a longitudinal direction.

23. Device according to claim 1, characterized in that in the web-processing machine (06) at least one processing station (07) is designed as a printing couple (07) in a rotary printing press (06).

24. Device according to claim 23, characterized in that with the printing couples (07) the rotary printing press (06) has a horizontal web path.

25. Device according to claim 1, characterized in that the storage area (11; 22; 24) is designed as a FIFO storage area.

26. Device according to claim 4, characterized in that the actuation of the transport carriage (27; 32) is accomplished via chain drives.

27. Device according to claim 1, characterized in that at least some of the storage spaces (13) and/or the branch lines (16) allocated to the storage spaces (13) accommodate a single transport carriage (27).

28. Device according to claim 1, characterized in that the majority of the storage spaces (13) and/or the branch lines (16) allocated to the storage spaces (13) accommodate a single transport carriage (27).

29. Device according to claim 1, characterized in that all the storage spaces (13) and/or the branch lines (16) allocated to the storage spaces (13) accommodate a single transport carriage (27).

30. Device according to claim 27, characterized in that at least a portion of the storage spaces (13) and/or the branch lines (16) allocated to the storage spaces (13) accommodate two transport carriages (27)

31. Device according to claim 1, characterized in that two storage areas (11; 11′) are arranged, each with a second transport carriage (32).

32. Device according to claim 31, characterized in that the transport routes (14) for the two transport carriages (32) are arranged extending parallel to one another.

33. Device according to claim 31, characterized in that the two storage areas (11; 11′) are connected to one another via a track.

34. Device according to claim 31, characterized in that a splice preparation station (03) is arranged between the two storage areas (11; 11′),

35. Device according to claim 34, characterized in that the second transport carriage (32) is arranged to transport the splice-prepared reels of material (01) into the storage area (11; 11′).

36. Device according to claim 1, characterized in that at least two storage spaces (13), and/or branch lines (16) allocated to said storage spaces (13), arranged directly one in front of another in the longitudinal direction of the web-processing machine (06), have a spacing (a) that is greater than a maximum diameter (Dₘₐₓ) of the reel of material (01) to be transported.

37. Device according to claim 1, characterized in that at least two storage spaces (13), and/or branch lines (16) allocated to said storage spaces (13), arranged directly one in front of another in the longitudinal direction of the web-processing machine (06), have a spacing (a) that is dimensioned such that two new reels of material (01) can be or are stored.

38. Device according to claim 1, characterized in that the majority of storage spaces (13), and/or branch lines (16) allocated to said storage spaces (13), arranged directly one in front of another in the longitudinal direction of the web-processing machine, have a spacing (a) that is greater than a maximum diameter (Dₘₐₓ) of the reel of material (01) to be transported.

39. Device according to claim 1, characterized in that the majority of storage spaces (13), and/or branch lines (16) allocated to said storage spaces (13), arranged directly one in front of another in the longitudinal direction of the web-processing machine (06), have a spacing (a) that is dimensioned such that two new reels of material (01) can be or are stored.

40. Device according to claim 1, characterized in that all the storage spaces (13), and/or branch lines (16) allocated to said storage spaces (13), arranged directly one in front of another in the longitudinal direction of the web-processing machine (06), have a spacing (a) that is greater than a maximum diameter (Dₘₐₓ) of the reel of material (01) to be transported.

41. Device according to claim 1, characterized in that all the storage spaces (13), and/or branch lines (16) allocated to said storage spaces (13), arranged directly one in front of another in the longitudinal direction of the web-processing machine (06), have a spacing (a) that is dimensioned such that two new reels of material (01) can be or are stored.

42. Device according to claim 2, characterized in that at least three storage spaces (13) for reels of material (01) are arranged on each side of the transport route (12).

43. Device according to claim 1, characterized in that new reels of material (01) can be or are stored in at least two storage spaces (13) that are arranged directly one in front of another in the longitudinal direction of the web-processing machine (06).

44. Device according to claim 1, characterized in that new reels of material (01) can be or are stored in the majority of storage spaces (13) that are arranged directly one in front of another in the longitudinal direction of the web-processing machine (06).

45. Device according to claim 1, characterized in that new reels of material (01) can be or are stored in all the storage spaces (13) that are arranged directly one in front of another in the longitudinal direction of the web-processing machine (06).

46. Device according to claim 1, characterized in that reels of material (01) having a maximum diameter (Dₘₐₓ) can be stored in at least two storage spaces (13) that are arranged directly one in front of another in the longitudinal direction of the web-processing machine (06).

47. Device according to claim 1, characterized in that reels of material (01) having a maximum diameter (Dₘₐₓ) can be stored in the majority of storage spaces (13) that are arranged directly one in front of another in the longitudinal direction of the web-processing machine (06).

48. Device according to claim 1, characterized in that reels of material (01) having a maximum diameter (Dₘₐₓ) can be stored in all the storage spaces (13) that are arranged directly one in front of another in the longitudinal direction of the web-processing machine (06).

49. Device according to claim 43, characterized in that the new reels of material (01) are provided with splices (15).

50. Device according to claim 1, characterized in that the longitudinal direction and the direction of web travel in the web-processing machine (06) extend essentially in the same direction

51. Device according to claim 1, characterized in that no rotating platform for the transport carriages (27) is arranged between the storage spaces (13) and the reel changer (09).

52. Device according to claim 5, characterized in that no rotating platform for the transport carriages (27) is arranged between the storage spaces (13) and the splice preparation station (03).

53. Device according to claim 23, characterized in that at least one printing couple (07), the reel changer (09) and the storage spaces (13) are arranged nearly in a single common plane (20).

54. Device according to claim 53, characterized in that all printing couples (07) are arranged in a single common plane (20).

55. Device according to claim 1, characterized in that the web-processing machine (06) has a single reel changer (09).

56. Device according to claim 1, characterized in that for the majority of storage spaces (13), each storage space (13) has its own drive for transporting the reels of material (01).

57. Device according to claim 4, characterized in that for the majority of storage spaces (13), each storage space (13) is equipped with a separate under-floor conveyance system for the transport carriage (27).

58. Device according to claim 57, characterized in that the under-floor conveyance system has a continuous mode of propulsion.

59. Device according to claim 58, characterized in that the mode of propulsion is designed as a chain.

60. Device according to claim 4, characterized in that each first transport carriage (27) is equipped with its own drive.

61. Device according to claim 56, characterized in that each storage space (13) is equipped with its own drive.

62. Device according to claim 57, characterized in that each storage space (13) is equipped with its own under-floor conveyance system.
